(19) United States
(12) Patent Application Publication
(10) Pub. No.: US 2005/0061252 A1
(43) Pub. Date: Mar. 24, 2005

(54) Pet feeding dish and method

(76) Inventors: Glenn Meeks, St. Petersburg, FL (US); Dennis Spruil, Orlando, FL (US)

Correspondence Address: Schwegman, Lundberg, Woessner & Kluth, P.A., P.O. Box 2938, Minneapolis, MN, 55402, US

(21) Appl. No.: 10/910,949

(22) Filed: Aug. 4, 2004

Related U.S. Application Data
(60) Provisional application No. 60/492,399, filed on Aug. 4, 2003.

(51) Int. Cl. A01K 5/02

(52) U.S. Cl. 119/51.02

(57) ABSTRACT

A pet feeding system is provided. One system uses pulse width identification to provide a more effective identification of a unique signal from a remote circuit on a pet tag. One system described is capable of identifying more than one remote circuit, such as two or more pets, at the same time. Further, one system includes the ability to detect a large distance range using inexpensive circuitry. A desired range can be user selected from a range of distances, using a control such as a potentiometer.

### CROSS-REFERENCE TO RELATED APPLICATION

This application claims the benefit of U.S. Provisional Application No. 60/492,399, filed on Aug. 4, 2003, under 35 U.S.C. § 119(e), which is hereby incorporated by reference.

### TECHNICAL FIELD

This invention relates to data transmitting and receiving systems.

Specifically, this invention relates to pet feeding systems that recognize unique pets and feeding conditions and operate to feed the pets accordingly.

### BACKGROUND

Pets frequently require special diets where strict feeding schedules are required. Strict feeding schedules can be difficult for pet owners to remember. Multiple pets also frequently pose a problem, where a more dominant pet will eat the food of other pets, thus depriving the other pets of food.

Some products have attempted to address these issues by using a pet tag that actuates a pet food dish, however the product attempts to date have a number of problems. They are expensive to manufacture due to issues such as expensive electronic circuitry used. They do not reliably read pet tag signals, and frequently experience transient signals that make the pet tag difficult to detect. They are not capable of recognizing multiple pets at the same time. They require large amounts of power to operate, requiring the user to change batteries on the pet tag frequently.

What is needed is an improved pet feeding system and method that addresses these and other pet feeding concerns.

### BRIEF DESCRIPTION OF THE DRAWINGS

FIG. 1 shows a pet feeding system according to one embodiment of the invention.

FIG. 2 shows a block diagram of an operational circuit according to one embodiment of the invention.

FIG. 3 shows a block diagram of a remote circuit according to one embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

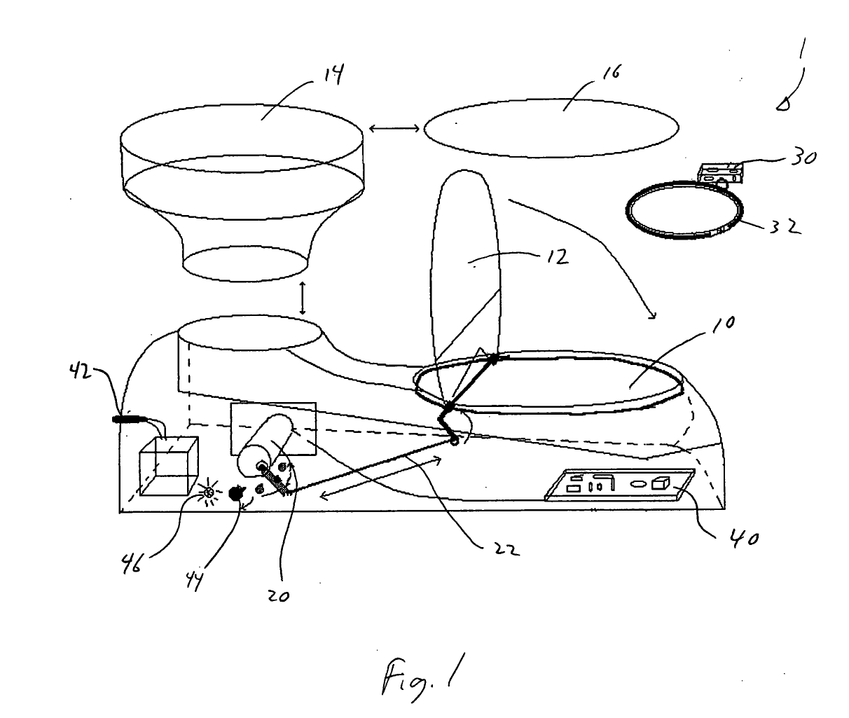

FIG. 1 shows one embodiment of a pet feeding system 1 for animals using gravity feed for dispensing and storing food for an animal to feed from. Other embodiments need not include a gravity feed configuration. Device may be round, square or tubular in shape. Height may vary as well as size. A holder or hopper 14 with a lid 16 holds the food above and behind feeding container 10. Sloped feeding bottom allows food to slide by gravity down to dish cavity on end. Holder or hopper may screw on or fasten by alignment guides by means of a sleeve that holds feeder holder on. Feeder top has lid 12 to protect stored food. This can be made from any material such as plastic or metal.

Feeder will open and close lid over feeding area and seal when lid 12 is closed by means of a recessed lip just under lid closing area. Lid will open by means of a cover actuation device 20 such as a motor or solenoid when power is applied. Motor or solenoid will be DC voltage for safety and battery operation. In one embodiment, a linkage 22 is used to couple the cover actuation device 20 to the lid 12. Motor has slip bushing for slipping when obstructed. The motor or solenoid will move the lid upward by use of a lever and push rod or worm gear movement. The push rod or worm gear will open lid by pushing on the hinged lever arm that is attached to the lid. The hinge is attached to the top of the feeding area allowing the lid to recess into the feeder body when closed. A small hole allows the push rod to access the lid hinge lever from the drive device.

An electronic circuit using microchips will control the motor or drive unit. It will sense lid open or closed by switches and magnets indicating position of lid. Hall effect devices may be used that are solid state and have no moving parts. The circuit will have relays or solid-state transistors to switch current to drive unit. The circuit will use programmable interrupt controller chips to allow programming of its functions. The circuit will have a radio receiver in the 200 to 400 Mgz range using less than 200 ma. of current on DC (Direct Current). The animal feeder, and an operation circuit 40, will operate using batteries or a plug in transformer connected at power input 42. AC voltage is stepped down to a low DC voltage and the transformer is in the wall to add safety. The receiver on the circuit will listen for the remote circuit 30 on animal collar 32 by using rs-232 data or pulse width. This will identify the signal and allow the programming to start processes to open lid 12. Many feeders may be in the same proximity or area by means of the transmitter sending the expected code or pulses for its receiver to understand only.

Programming allows for wrong codes or pulses to cause other functions to happen, such as two animals with different transmit codes would cause the lid to shut. Programming allows for timed feeding to a total amount fed in an allowed time. This allows animals to feed up to that time on their own feeding habits. There will be no open lid time until the next set time. A potentiometer switch is added to the circuit to measure signal strength from the transmitter so that the distance may be adjusted to desired lid open moment when animal or transmitter approaches. The receiver has a linear signal output for this function and by comparing voltages and using PIC's (Programmable Interrupt Controller) chips to average the voltage comparison. This allows setting of the open and close limits of the transmitter or animal. A signal light LED 46 (Light Emitting Diode) is added outside the dish to indicate when signal is present. The light will come on and flash when signal is present. It will flash faster as the potentiometer knob 44 is turned to indicate a closer setting. Diagnostic lights are added to the circuit as well for LED 46 indications of open/close switches, signal processed, and confirmed. This is for manufacturing visuals and calibrations. In one embodiment, signal strength (which correlates to a desired distance between the remote circuit 30 and the container 10) and a unique signature, such as pulse width or data from the remote circuit 30 must be present at the same time for the lid to open. This is done with the PIC chips and programming as well. This prevents false opening or closing of the lid from stray signals or noise. Programming also allows the feeder to call an animal to feeding at pre-set times by using voice chips or beeping.

The transmitter is using less than 0.2 ma current and operates on 200 mgz to 399.94 mgz. Multiple frequencies are used as well as the width of the data RS-232 or pulses to determine the correct transmitter is in range. The transmit time is variable as to conserve power and utilizing a smaller battery as to keep the size small as possible. Transmitter may be as small as a half of book of matches' ½ in by ½ in. The transmitter utilizes micro technology circuits composing of one PIC chip and ultra small transmitter with a resistor pack and battery. Battery is common and small as in a calculator, size of two quarters. Battery is replaceable by end user and will last six months or longer. Final circuit is placed in bath of sealant and battery holder is left open. This protects transmitter from water and rain. The PIC chips will put the transmitter to sleep and uses only 0.1 ma in sleep mode. The transmit time is programmable as well. This is adjustable to usable rates such as transmit at 1.7 ma for 1/10 second and sleep at 0.001 ma for 9/10 of a second. This allows for low battery consumption and a longer battery life. When the transmitter battery gets low, an audible indicator and/or visual will alert owner at feeder. This will indicate to the owner that it is time to replace collar “transmitter” battery.

Anti-jam—The “programming” of the logic in the circuit allows the unit to shut down if the lid is prevented from closing or opening. Then gives an audible sound from the main dish to the owner. The feeding times can be set for schedules to open and when not to. This can be per day or hour and can be set with a PDA, PC, or remotely via modem. It also can be appreciated that the owner can view the times of the animal feeding habits to see when feeding is occurring and how long the times are. Also the unit “feeder” can be set via “programming” to alert the owner by audio or visual, that the animal has not fed in a certain time. This would be helpful for knowing when animals may be sick or ill or if there was a malfunction or other problem. Feeder has an override switch that allows the owner to open lid continuously when desired. Unit can keep “wet food” clean, fresh and bug free. This will also keep flying insects out as well as small children.

In one embodiment, the feeder system utilizes proximity induced power technology. In one embodiment, the feeder system uses battery powered technology with power saving configurations as described above. One embodiment using a battery uses a transmitter (on collar) and a receiver (inside feeder). Battery powered embodiments have certain advantages over proximity induced power embodiments. A prox device is referred to as a “Tag” or “Transceiver”, or RFID. Advantage of prox is that there is no battery in the “Tag” or “transceiver”

Disadvantages include higher cost and a normal read range of three inches. Using this prox technology would prohibit the use of a normal flip up lid on the feeder. The animal would approach feeder and the head of the animal would be directly over the lid open area. The animal would trigger the lid and then the lid would move upwards tilting the prox and head of animal upward. This would then cause the animal to go out of range again and reverse lid downward again. This problem would compound as the animal becomes larger in size, such as larger breeds or growing. Disadvantage of a lid that opens by spinning or sliding out is that the spinning lid causes a trap area to form if an animal head is with in it. Any thing that can close behind the shape of an animal head can potentially trap or bind. The sliding lid that could slide left or right would mean the animal could only feed from a certain direction. The feeder could not be placed next to a wall or have any thing in the way of the slide out lid. The flip up lid method uses no extra space and cannot trap or bind an animal due to it geometric shape like opening a file folder.

Although a larger range using prox technology is possible, the electronic devices, such as chips, necessary to increase the range over three inches can be very expensive.

Battery powered remote circuit embodiments can be adjusted from three inches from feeder to over fifteen feet outwards using minimally expensive circuitry. In one embodiment, the distance is adjusted by a turn knob on the feeder. The owner can set the distance needed and allow a learning curve for the animal. The lid on the feeder would be open before the animal reached the feeder. This causes less fear and a faster learning curve. This also adds another feature the proximity cannot do. Since a Prox tag can only read three inches to eight inches, it should be noted that two animals would be able to feed at a given moment. For instance if an aggressive animal wearing a prox tag were to approach a already feeding animal wearing a prox tag also, It would be able to steal food each visit. Even if this prox technology saw two tags at once and shut the lid on the feeder. The animal would just repeat this process over and over. This is because of the short read range of the prox tags. Using battery powered remote circuits, the signal from our transmitter (collar) can pick up a signal further out (adjustable). This means the lid would be shut before the arrival of the second animal trying to feed. Thus no extra feeding which is the one of the major reasons for this invention.

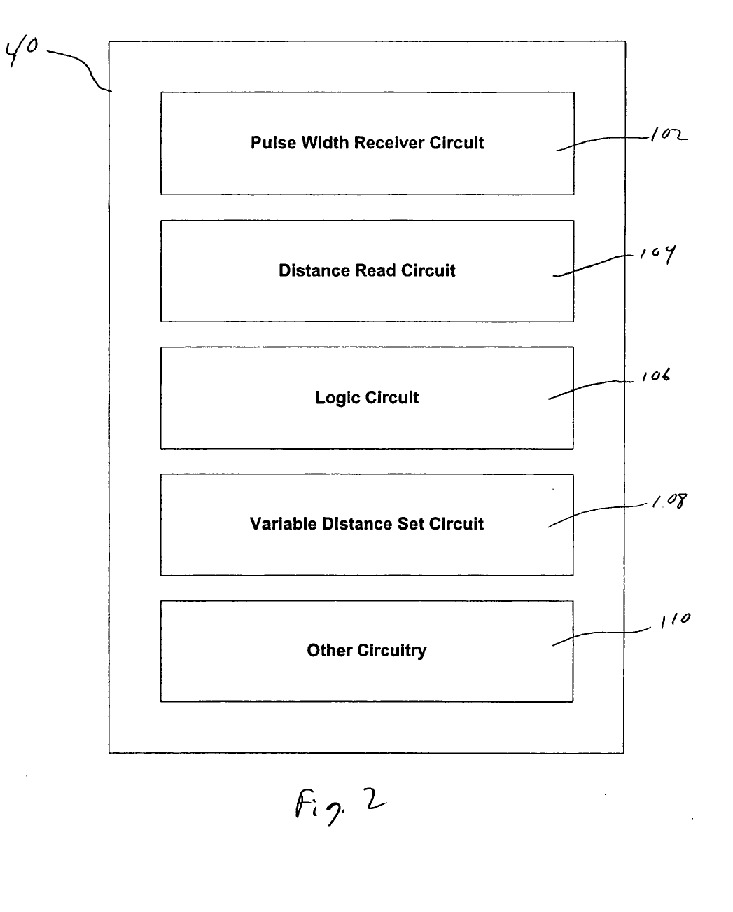

FIG. 2 shows detail of the operation circuit 40 from FIG. 1. In one embodiment, the operation circuit 40 includes a receiver circuit 102. In one embodiment, the receiver circuit 102 is a pulse width receiver circuit. In one embodiment, the operation circuit 40 includes a distance read circuit 104. In one embodiment, the operation circuit 40 includes a logic circuit 106 that uses input data such as data from the receiver circuit 102 and the distance read circuit 104 to selectively open the lid 12 as shown in FIG. 1. In one embodiment, the operation circuit 40 includes a variable distance set circuit 108. The user can select a given distance of the remote circuit 30 from the container 10 where the lid 12 should open using the variable distance set circuit 108. Other circuitry 110 may also be included in the operation circuit 40.

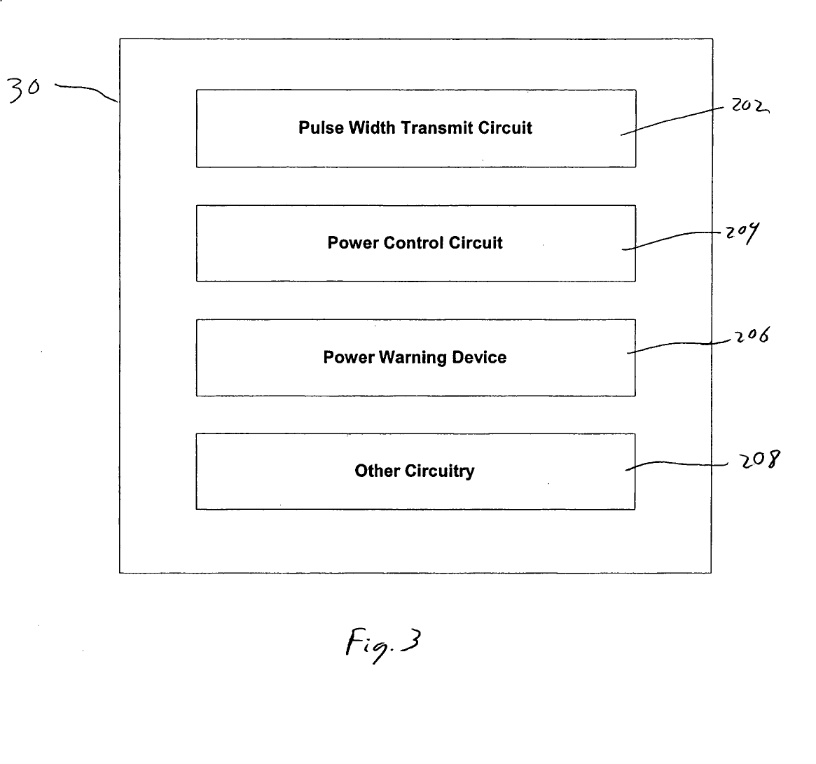

FIG. 3 shows detail of the remote circuit 30 from FIG. 1. In one embodiment, the remote circuit 30 includes a transmit circuit 202. In one embodiment, the transmit circuit 202 is a pulse width transmit circuit. In one embodiment, the remote circuit 30 includes a power control circuit 204. As described above, the power control circuit 204 includes embodiments such as a transmit mode and a sleep mode where battery power is conserved by limiting the transmit time. In one embodiment, the remote circuit 30 includes a power warning device 206. As described above, the power warning device 206 includes devices such as an audible indicator and/or visual that will alert the owner. Other circuitry 208 may also be included in the remote circuit 30.

Our invention and technology allows our design to use the same Collar (transmitter), to incorporate many other advantages, like replacing the motor or drive unit in the feeder with a ultra high sound speaker. This would be placed in an area that the animal was not allowed to go. This could be a baby's crib or any other room or area. The unit would then make sound that the animal would not wish to listen to and a human cannot hear. Using the maximum range coupled with user adjustable, we can achieve many other products that protect animals and human interest. This would use the same collar to control animal behavior without shock or harm.

### Conclusion

There are a number of advantages to embodiments as described above. The use of pulse width identification provides a more effective identification of the unique signal from the remote circuit on a pet tag. Data identifiers such as RF signal data can become more easily confused due to transient signals or reflection signals. Further, pulse width identification is more capable of identifying more than one remote circuit, such as two or more pets, at the same time. Other RF circuits are more likely to become confused with two or more signals being received at the same time.

Another advantage of embodiments as described above includes the ability to detect a large distance range using inexpensive circuitry, in contrast to a proximity circuit. A desired range can be user selected from a range of distances, using a control such as a potentiometer.

Another advantage of embodiments as described above includes a power saving circuit in the remote circuit to extend battery life.

While a number of advantages of embodiments described herein are listed above, the list is not exhaustive. Other advantages of embodiments described above will be apparent to one of ordinary skill in the art, having read the present disclosure. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

1. A pet feeding system comprising:
a food container;
a food container cover;
an cover actuation device adapted for selective actuation of the food container cover between an open state and a closed state;
a remote circuit adapted for attachment to a pet, wherein the remote circuit is configured to provide a pulse width signal unique to the pet;
an operation circuit coupled to the cover actuation device, including:
a pulse width receiver circuit to detect the pulse width signal;
a distance circuit to detect a distance of the remote circuit from the food container; and
a logic circuit to selectively actuate the cover actuation device based on information from the pulse width receiver circuit and the distance circuit.

2. The pet feeding system of claim 1, wherein the remote circuit includes a transmit mode and a sleep mode.

3. The pet feeding system of claim 1, wherein the logic circuit recognizes a user selected distance from a range of possible distances.

4. The pet feeding system of claim 1, wherein the logic circuit includes circuitry to recognize a plurality of remote circuits at the same time.
